(19) United States
(12) Patent Application Publication
(10) Pub. No.: US 2008/0268191 A1
(43) Pub. Date: Oct. 30, 2008

(54) INSERT MOLDING ARTICLE AND METHOD FOR MAKING THE SAME

(75) Inventors: QIAN-LONG LIAO, Shenzhen (CN); SHAN-GU XIAO, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Taipei Hsien (TW)

(21) Appl. No.: 11/770,757

(22) Filed: Jun. 29, 2007

(30) Foreign Application Priority Data
Apr. 24, 2007 (CN) 200710200500.X

(51) Int. Cl. B32B 3/12

(52) U.S. Cl. 428/35.7; 264/254

(57) ABSTRACT

An exemplary insert molding article includes an elastomer element and an insert element. The insert element defines a plurality of through holes thereon. The elastomer element covers one side surface of the insert element and fills the through holes of the insert element. Methods for making the insert molding article are also provided.

### BACKGROUND OF THE INVENTION

1. Field of the Invention

The present invention relates, generally, to an insert molding article, and particularly, to an insert molding article including an elastomer element and an insert element made of other materials, and a method for making the insert molding article.

2. Discussion of the Related Art

Some workpieces include different portions made of different materials. Many kind of these workpieces are manufactured by means of insert molding and are called insert molding articles. For example, a housing of an electronic device includes a plastic element and an insert element made of another material. When the housing is manufactured, the insert element is placed in a mold, and melted plastic is injected into the mold. After the melted plastic solidifies, the plastic element confines the insert element, and the housing is completed.

Nowadays, in order to obtain an electronic device with an elegant neo-design and a comfortable-touching texture, the electronic device usually employs a housing manufactured by insert molding technology, and a plastic element of the housing is typically made of elastomer materials. The elastomer materials have soft property so that gives the electronic device the comfortable-touching texture. The housings of the electronic devices include an insert element and an elastomer element covering an outer surface of the insert element.

Generally, an area of the elastomer element is relatively large, and a fluid flow rate of the melted elastomer element is relatively great. When melted elastomer materials are injected into a mold to form the elastomer element, vapor, air, and gases produced by the melted elastomer is hard to be completely removed from the mold. Thus, some of the gases, vapor, and air are trapped in the melted elastomer materials during production. After the melted elastomer element is cooled, bubbles are formed in the elastomer element. This results in that the housing is not uniform and elegant. In order to decrease the number of bubbles of the elastomer element, a number of gas vents are defined in the mold, and/or a pumping device is added to the mold to remove the air and other gases out of the mold in production. However, the methods described above do not completely eliminate the bubbles. Further, in production, a number of burrs of the elastomer element may occur due to the gas vents defined in the mold.

What is needed, therefore, is an insert molding article that overcomes the above mentioned disadvantages. Methods for making the insert molding article are also desired.

### SUMMARY

In one aspect, an insert molding article according to a preferred embodiment includes an elastomer element and an insert element. The insert element defines a plurality of through holes thereon. The elastomer element covers one side surface of the insert element and fills the through holes of the insert element.

In another aspect, a method for making an insert molding article includes: injecting one or more melted resin materials into a first mold to form an insert element; figuring out areas that are prone to trap gases according to injection molding analysis of the insert molding article; punching the insert element to form a plurality of through holes according to the areas prone to have gas-traps; placing the insert element into a second mold; injecting the elastomer material into the second mold to form an elastomer element covering one side surface of the insert element and filling the through holes of the insert element.

Other advantages and novel features will become more apparent from the following detailed description of the preferred embodiments, when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present insert molding article and method for making the insert molding article. Moreover, in the drawings, like reference numerals designate corresponding parts throughout the several views, and all the views are schematic.

FIG. 1 is an isometric view of an insert molding article according to a preferred embodiment of the present invention.

FIG. 2 is a top plan view of the insert molding article of FIG. 1.

FIG. 3 is a bottom plan view of the insert molding article of FIG. 1.

FIG. 4 is a cut-away view of the insert molding article of FIG. 1.

FIG. 5 is an enlarged view of a circle portion V of FIG. 1.

### DETAILED DESCRIPTION OF THE PREFERRED EMBODIMENTS

Reference will now be made to the drawings to describe preferred embodiments of the present insert molding article and methods for making the insert molding article, in detail.

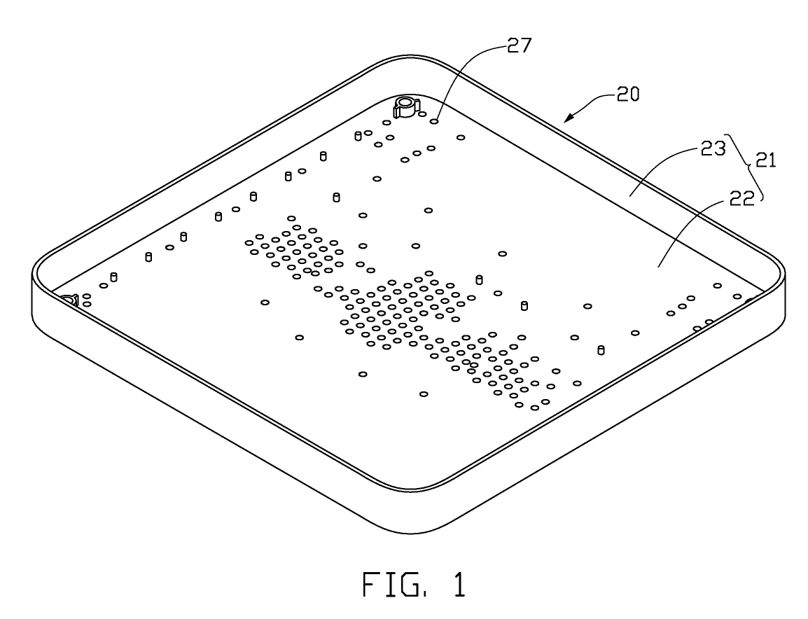

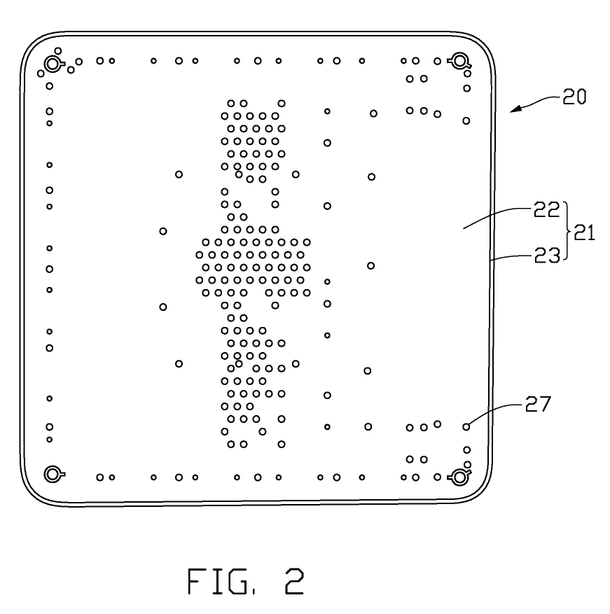

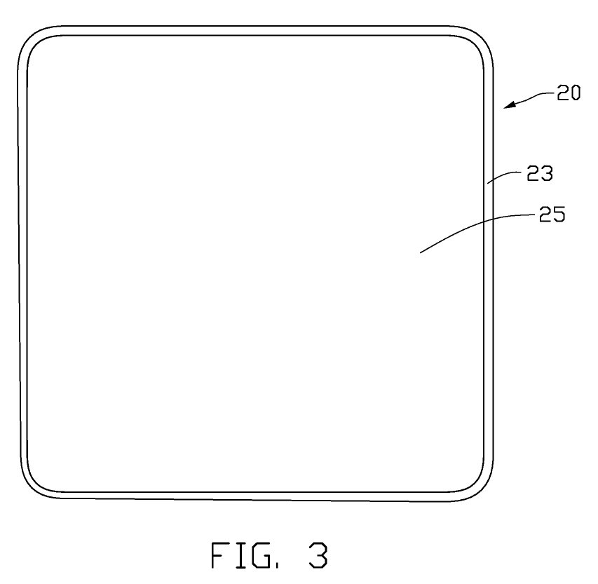

Referring to FIGS. 1 through 3, an insert molding article 20 in accordance with a preferred embodiment of the present invention is shown. The insert molding article 20 can be used to make up a housing of an electronic device. The insert molding article 20 includes an insert element 21 and an elastomer element 25. The insert element 21 makes up a main body of the housing. The insert element 21 includes a square base 22 having four round corners, and a rim 23 extending perpendicularly around a periphery of the base 22. The base 22 defines a plurality of through holes 27. The through holes 27 are densely distributed at a center portion and four corners of the base 22. The insert element 21 is made of polycarbonate (PC). The elastomer element 25 is a thin film having a flat outer surface. The elastomer element 25 covers an outer surface of the base 22 and fills the through holes 27 of the insert element 21. In this embodiment, the elastomer element 25 is made of thermoplastic elastomer (TPE).

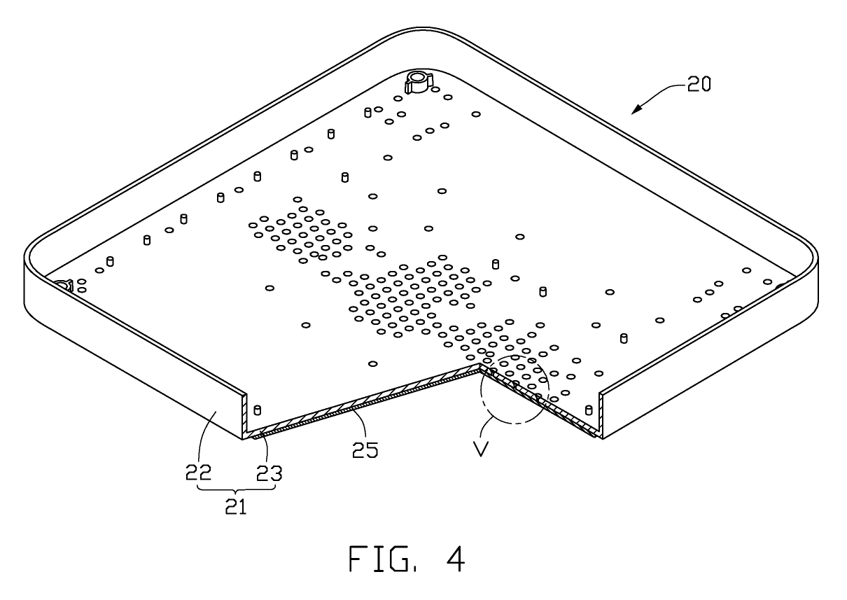

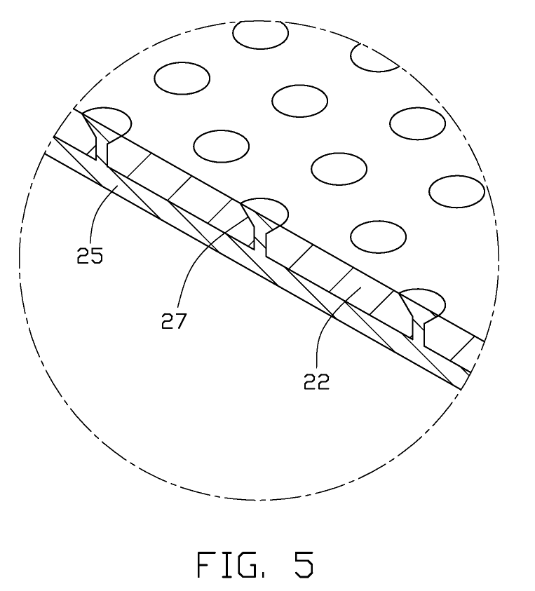

Referring to FIGS. 4 and 5, in this embodiment, in order to improve a bonding strength between the insert element 21 and the elastomer element 25, each of the through holes 27 is configured to be funnel-shaped. A first opening of the through hole 27 on the outer surface of the base 22 is configured to be smaller than a second opening of the through hole 27 on an inner surface of the base 22. In alternative embodiments, the through holes 27 can be configured as other shapes, such as a conical-frustum or conical, as long as a diameter of the first opening of each through hole 27 adjacent to the elastomer element 25 is smaller than that of the second opening of each through hole 27 adjacent to the inner surface of the base 22.

The insert molding article 20 is manufactured by insert molding method. Before forming the elastomer element, gas trapped prone areas are calculated by an injection molding analysis according to the structure of the insert molding article 20. The through holes 27 are defined in the insert element 21 according to the calculated positions of where bubbles are likely to be formed. During production, when melted plastic flows into the molding space, gases produced by the melted elastomer materials, vapor and air in the mold can be efficiently removed from the mold via the through holes 27. Therefore, after the melted elastomer element 25 is cooled, less bubbles is formed in the elastomer element, such that the insert molding article 20 is obtained with an elegant neo-design.

It should be pointed out that, the rim 23 of the insert element 21 can be omitted, or the base 22 of the insert element 21 can be other shapes.

An exemplary method for making the insert molding article 20 of FIG. 1 will now be described. The method mainly includes the following three steps.

Step one: a first mold is provided to create the insert element 21 by injection molding. In this embodiment, melted polycarbonate (PC) is injected into the first mold. The melted PC solidifies, thereby yielding the insert element 21. In alternative embodiments, the insert element 21 can be made of acrylonitrile-butadiene-styrene (ABS), or any other suitable plastic materials having a good mechanical strength.

Step two: a flow direction of a melted elastomer material and gas trapped prone areas are calculated by an injection molding analysis of the insert molding article 20. In this embodiment, positions susceptible to gas accumulation are mainly in the center portion and the corners of the base 22.

Step three: punching the insert element 21 and thereby forming the plurality of through holes 27 in the insert element 21 according to the positions of gas trap effect.

Step four: a second mold is provided to create the insert molding article by insert molding. The insert element 21 is placed in the second mold. The melted elastomer material is injected into the second mold to form an elastomer element 25 substantially covering the outer surface of the insert element 21. A melting point of the insert molding article is higher than that of the elastomer material.

It should be noted that, before the step four, the second mold should be accurately designed base on an actual size of the insert element 21. Therefore, a calculation of a shrinkage rate of the insert element 21 is very important.

It is to be understood that, if the structure of the insert element having a plurality of through holes is determined, another exemplary method for making an insert molding article is provided. Firstly, an insert element having the through holes is provided, and the insert element can be made of either glass or metal. Secondly, the insert element is placed into a mold. Finally, a melted elastomer material is injected into the mold to form the insert molding article.

Finally, while the present invention has been described with reference to particular embodiments, the description is illustrative of the invention and is not to be construed as limiting the invention. Therefore, various modifications can be made to the embodiments by those skilled in the art without departing from the true spirit and scope of the invention as defined by the appended claims.

What is claimed is:

1. An insert molding article, comprising:
an insert element, the insert element defining a plurality of through holes thereon; and
an elastomer element covering one side surface of the insert element and filling the through holes of the insert element.

2. The insert molding article according to claim 1, wherein a melted temperature of the insert element is higher than that of the elastomer element.

3. The insert molding article according to claim 2, wherein the insert element is made of one of polycarbonate and acrylonitrile-butadiene-styrene.

4. The insert molding article according to claim 2, wherein the elastomer element is made of thermoplastic elastomer.

5. The insert molding article according to claim 1, wherein a diameter of a first opening of each through hole adjacent to the elastomer element is smaller than that of a second opening of each through hole adjacent to the inner surface of the base.

6. The insert molding article according to claim 5, wherein each of the through holes is selected from a group consisting of funnel-shaped, conical-frustum shape and a conical shape.

7. A method for making an insert molding article, comprising:
injecting one or more melted resin materials into a first mold to form an insert element;
figuring out areas that are prone to trap gases according to injection molding analysis of the insert molding article;
punching the insert element to form a plurality of through holes according to the areas prone to have gas traps;
placing the insert element into a second mold;
injecting the elastomer material into the second mold to form an elastomer element covering one side surface of the insert element and filling the through holes of the insert element.

8. The method for making an insert molding article as claimed in claim 7, wherein a melted temperature of the insert element is higher than that of the elastomer element.

9. The method for making an insert molding article as claimed in claim 8, wherein the insert element is made of one of polycarbonate and acrylonitrile-butadiene-styrene.

10. The method for making an insert molding article as claimed in claim 8, wherein the elastomer element is made of thermoplastic elastomer.

11. The method for making an insert molding article as claimed in claim 7, wherein a diameter of a first opening of each through hole adjacent to the elastomer element is smaller than that of a second opening of each through hole adjacent to the inner surface of the base.

12. The method for making an insert molding article as claimed in claim 11, wherein each of the through holes is selected from a group consisting of a funnel-shaped hole, a conical-frustum hole and a conical hole.

13. A method for making an insert molding article, comprising:
providing an insert element defining a plurality of through holes;
placing the insert element into a mold;
injecting a melted elastomer material into the mold to form an elastomer element covering one side surface of the insert element and filling the through holes of the insert element.

14. The method for making an insert molding article as claimed in claim 13, wherein a melted temperature of the insert element is higher than that of the elastomer element.

15. The method for making an insert molding article as claimed in claim 14, wherein the insert element is made of one of polycarbonate and acrylonitrile-butadiene-styrene.

16. The method for making an insert molding article as claimed in claim 14, wherein the elastomer element is made of thermoplastic elastomer.

17. The method for making an insert molding article as claimed in claim 13, wherein a diameter of a first opening of each through hole adjacent to the elastomer element is smaller than that of a second opening of each through hole adjacent to the inner surface of the base.

18. The method for making an insert molding article as claimed in claim 17, wherein each of the through holes is selected from a group consisting of a funnel-shaped hole, a conical-frustum hole and a conical hole.
